(19) United States
(12) Patent Application Publication
(10) Pub. No.: US 2006/0042659 A1
(43) Pub. Date: Mar. 2, 2006

(54) Robotic system and method for circumferential work processes and delivery of a medium

(75) Inventors: Edison Fernandez, Phoenix, AZ (US); Troy A. Wilfong, Goodyear, AZ (US); Michael W. James, Lyons, NY (US); Stephen S. Mounnarat, Penfield, NY (US); Edward R. Welch, Rochester, NY (US); Terry M. Radigan, Scottsville, NY (US); Frank P. Amie III, Newark, NY (US); Curt K. Manley, Geneva, NY (US)

Correspondence Address: Lowell W. Gresham;Meschkow & Gresham, PLC, Suite 409, 5727 North Seventh Street, Phoenix, AZ, 85014, US

(73) Assignee: Pinnacle West Capital Corporation, Phoenix, AZ (US)

(21) Appl. No.: 10/932,180

(22) Filed: Sep. 1, 2004

(51) Int. Cl. B08B 9/00

(52) U.S. Cl. 134/22.1; 134/34; 134/172; 134/198; 134/22.12

(57) ABSTRACT

A system (42) for treating a columnar element (22) at a remote location (28) includes a vehicle (68) having a moveable base (98), a clamp (100) attachable to the columnar element (22), a rotating member (104), and a jack (108) having an effector (112) coupled to the rotating member (104). The jack (108) and rotating member (104) lift the effector (112) above the base (98) and rotate the effector (112) about the columnar element (22). A vehicle controller (58), remote from the vehicle (68), but in communication with the vehicle (68), controls the components of the vehicle (68). A method (186) for treating the columnar element (22) using the vehicle (68) entails navigation and positioning of the effector (112) at the region of interest (30) via the vehicle controller (58), and enabling delivery of a medium (72) from the effector (112) about a circumference of the columnar element (22).

### TECHNICAL FIELD OF THE INVENTION

The present invention relates to the field of nuclear reactors. More specifically, the present invention relates to cleaning the reactor pressure vessel bottom mounted instrumentation nozzles.

### BACKGROUND OF THE INVENTION

A pressurized water reactor (PWR) is a nuclear power reactor that uses ordinary (light) water as both coolant and neutron moderator. In a PWR, the primary coolant loop is pressurized so the water does not boil, and heat exchangers, i.e., steam generators, transmit heat to a secondary coolant which is allowed to boil to produce steam for electricity generation, for warship propulsion, and so forth. The reactor pressure vessel contains the reactor fuel, moderator, and coolant under pressure and is the part of the nuclear reactor that produces heat. Some reactor pressure vessels include bottom mounted instrumentation (BMI) nozzles that penetrate the lower head of the reactor pressure vessel. The BMI nozzles may be used, for example, for housing flux monitoring instrumentation.

FIG. 1 shows an elevation view of a portion of an exemplary reactor pressure vessel 20. As shown, columnar elements in the form of bottom mounted instrumentation (BMI) nozzles 22 extend below a lower head 24 of reactor pressure vessel 20. Reactor pressure vessel 20 is enclosed, at least in part, by an insulation package 26 having an insulation floor 27 that provides a degree of radiation shielding. The cavity under reactor pressure vessel 20 is considered a very high radiation area (VHRA) 28. In the nuclear industry vernacular, the term “VHRA” refers to an area accessible to individuals, in which radiation levels could exceed 500 rad (5 gray) in one hour at 1 meter from the source or from any surface that the radiation penetrates.

Through bare-metal visual inspections of penetration regions 30 of BMI nozzles 22 into reactor pressure vessel 20, it has been discovered that leakage at a penetration region 30 can occur. Indeed, such leakage was discovered during a refueling outage at the South Texas, Unit 1, nuclear reactor. The residue from this leakage was subsequently found to contain both boric acid and long-term radionuclides, confirming the source to be the reactor coolant system.

As a result of this event, the Nuclear Regulatory Commission (NRC) issued Bulletin 2003-02 indicating that a significant leak from one of penetration regions 30 could introduce safety concerns in that it would require the actuation of the nuclear reactor safety systems and operation for an extended period of time making it difficult to stabilize the plant. Thus, NRC Bulletin 2003-02 strongly recommended that nuclear plants perform a bare-metal visual inspection of penetration regions 30 at each of BMI nozzles 22 of their reactor pressure vessels 20 during a next refueling outage.

It has further been discovered that many BMI nozzles 22 have remnants of a protective coating 32 left from construction. Protective coating 32, also known as Spraylat, is a latex based paint used to protect metallic components during shipment. Protective coating 32, as well as, rust oil staining, tape, and so forth, creates problems for a bare-metal inspection of one hundred percent of the circumference of each penetration region 30 at which one of BMI nozzles 22 enters reactor pressure vessel lower head 24 of reactor pressure vessel 20. Accordingly, it has been determined that in order to perform a reliable visual inspection of the entire circumferential surface 34 about each penetration region 30, protective coating 32 must first be removed to establish a clean bare-metal surface. Thereafter, reliable visual inspections can be performed at every refueling outage.

One proposed technique for cleaning BMI nozzle penetration regions 30 involves removing insulation package 26 beneath reactor pressure vessel 20, manually cleaning penetration regions 30 for BMI nozzles 22 in lower head 24 of reactor pressure vessel 20 by mechanical or chemical means, and then replacing the insulation. The labor involved for work under reactor pressure vessel 20 was estimated to entail a minimum of a four man crew for four shifts for insulation removal and installation of new insulation. The cleaning activity was estimated to entail a two man crew for two shifts, and craft support called for a six person crew for two shifts. In addition, work under reactor pressure vessel 20 requires that in-core instrumentation (not shown) be inserted at all times, thus delaying reactor core alterations during refueling. Obviously, such a labor intensive activity is costly, and any delays to reactor core alterations results in further additional costs.

Moreover, entry into, and work in, VHRA 28 can present very high radiation hazards. It is well known that exposure to radiation can cause health effects. These health effects may be fairly mild and transitory, such as, weakness, loss of appetite, vomiting, and diarrhea. On the other hand, these health effects may include delayed medical problems such as increased rate of infections, cancer, premature aging, birth defects in progeny, and so forth. Such health effects can occur after repeated large exposure or even after very small exposure in a plant or laboratory, since radiation effects are cumulative. Consequently, it is highly undesirable to expose personnel to the high radiation dosages that might occur by entering into and working in a VHRA, such as under the reactor pressure vessel.

Accordingly, what is needed is a system and method for cleaning a reactor pressure vessel bottom mounted instrumentation penetration region beneath a reactor pressure vessel of a nuclear reactor that minimizes radiation exposure to personnel, is cost effective to implement, and yields a clean bare metal surface around the circumference of each BMI nozzle so that reliable visual inspections may thereafter be performed.

### SUMMARY OF THE INVENTION

Accordingly, it is an advantage of the present invention that a system and method for circumferential work processes and delivery of a medium are provided.

It is another advantage of the present invention that a system and method are provided for remote cleaning of bottom mounted instrumentation (BMI) nozzles in a reactor pressure vessel.

It is another advantage of the present invention that the system and method limit personnel radiation exposure in a very high radiation area of a reactor pressure vessel through remote control of a cleaning vehicle.

Yet another advantage of the present invention is that the system and method are relatively time and cost effectively implemented, and do not require the removal of insulation around the reactor pressure vessel.

The above and other advantages of the present invention are carried out in one form by a system for treating a columnar element at a remote location. The system includes a vehicle including a base moveable along a floor of the remote location, a rotating member coupled to the base, and an effector coupled to the rotating member. The rotating member is configured to rotate relative to the base about the columnar element to enable the effector to act upon a circumferential surface of the columnar element. The system further includes a controller positioned remote from the vehicle. The controller is in communication with the vehicle for directing movement of the vehicle to the columnar element, for directing rotation of the rotating member, and for enabling the effector to work upon the circumferential surface.

The above and other advantages of the present invention are carried out in another form by a system for cleaning a columnar element at a remote location. The system includes a vehicle having a base moveable along a floor of the remote location and a nozzle in communication with the base for delivering a cleaning medium to a surface of the columnar element. A controller is positioned remote from the vehicle. The controller is in communication with the vehicle for directing movement of the vehicle to the columnar element and for enabling the nozzle to deliver the cleaning medium.

The above and other advantages of the present invention are carried out in another form by a method for treating a columnar element at a remote location using a remote controlled vehicle, the vehicle including a moveable base, a clamp mounted on the base, a jack in communication with the base, and an effector coupled to an end of the jack. The method calls for directing movement of the vehicle to the columnar element and actuating hinged jaws of the clamp to encircle the columnar element. The method further calls for extending the jack to lift the effector vertically above the base, and enabling delivery of a medium from the effector to a surface of the columnar element to clean the columnar element.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows an elevation view of a portion of an exemplary reactor pressure vessel;

FIG. 2 shows a block diagram of an exemplary environment in which cleaning and inspecting operations may take place;

FIG. 3 shows a perspective view of a cleaning vehicle in accordance with a preferred embodiment of the present invention;

FIG. 4 shows a perspective view of a base of the cleaning vehicle of FIG. 3 with a clamp mounted thereon;

FIG. 5 shows a front elevation view of the cleaning vehicle of FIG. 3;

FIG. 6 shows a perspective view of a first turntable configuration of the cleaning vehicle of FIG. 3 with a jack in an extended position;

FIG. 7 shows a side elevation view of the cleaning vehicle of FIG. 3 extended to reach a penetration region of one of the BMI nozzles in the exemplary reactor pressure vessel;

FIG. 8 shows a perspective view of a second turntable configuration of the cleaning vehicle of FIG. 3 in accordance with an alternative embodiment of the present invention;

FIG. 9 shows a perspective view of the second turntable configuration of FIG. 8 having a jack in an extended position mounted thereon.;

FIG. 10 shows a side view of a cable tensioner that may be utilized in the exemplary environment of FIG. 2;

FIG. 11 shows an exemplary block diagram of a vehicle control panel that may be operable for remote control of cleaning vehicle 68 (FIG. 3);

FIG. 12 shows a diagram of an exemplary drop-down menu of a cleaning robot controller program;

FIG. 13 shows a flowchart of a cleaning and inspection process performed within the exemplary environment of FIG. 2; and

FIG. 14 shows an exemplary illustration of a penetration region of one of the BMI nozzles following cleaning.

### DETAILED DESCRIPTION OF THE PREFERRED EMBODIMENTS

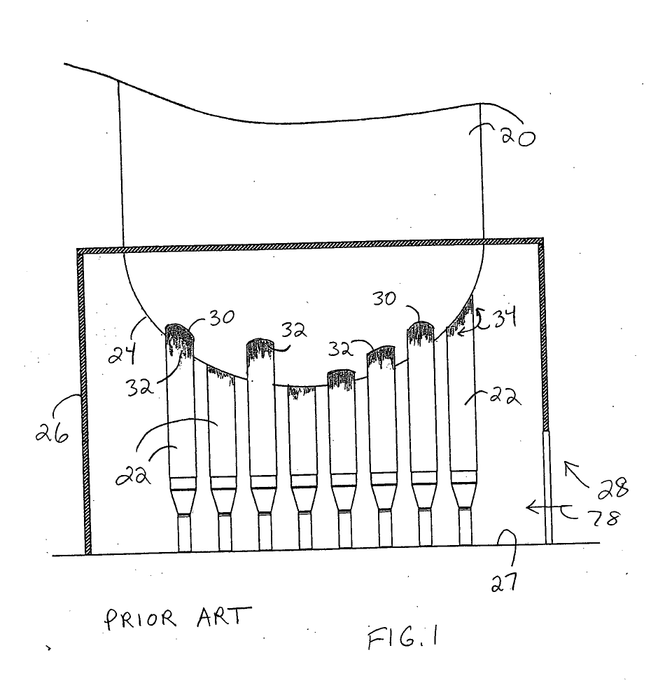

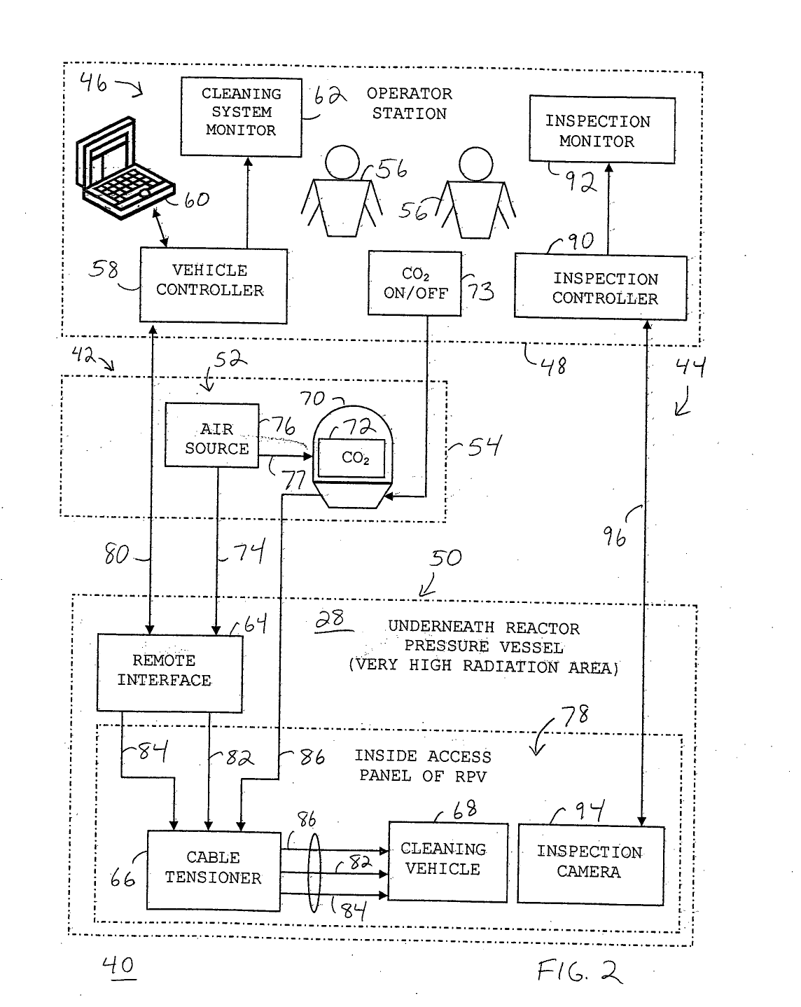

Referring to FIGS. 1-2, FIG. 2 shows a block diagram of an exemplary environment 40 in which cleaning and inspecting operations may take place. Exemplary environment 40 is a nuclear reactor facility that houses reactor pressure vessel 20. As discussed in detail above, NRC Bulletin 2003-02 strongly recommended that nuclear plants perform a bare-metal visual inspection of penetration regions 30 at each of BMI nozzles 22 of their reactor pressure vessels 20 during a refueling outage. In order to perform a reliable visual inspection, the entire circumferential surface 34 about each penetration region 30 of each BMI nozzle 22 must be a bare-metal surface.

A cleaning system 42 is implemented within environment 40 in accordance with a preferred embodiment of the present invention for cleaning penetration regions 30 of bottom mounted instrumentation (BMI) nozzles 22 to remove protective coating 32, rust, oil staining, tape, and any other potentially masking component that would limit the observation of residue from leakage in subsequent inspections. An inspection system 44 may be utilized thereafter for visually inspecting bare-metal circumferential surface 34 at penetration regions 30 following their cleaning.

Although both cleaning system 42 and inspection system 44 are implemented in environment 40, it should be understood that they need not necessarily be utilized together. For example, once cleaning system 42 has removed protective coating 32 from penetration regions 30 of all of BMI nozzles 22 during a first refueling outage, cleaning system 42 need not be utilized again during subsequent refueling outages.

In addition, cleaning system 42 is described below in terms of its function for removing protective coating 32 from penetration regions 30 of BMI nozzles 22. However, it should be understood that cleaning system 42 need not be limited to such an operation. Rather, cleaning system 42 may be adapted to clean a variety of columnar elements either within high radiation environments or in environments in which radiation levels are not a concern. Moreover, it will become apparent in the ensuing discussion that cleaning system 42 may be further adapted to perform operations, other than cleaning, upon a surface of a columnar element. Such operations may include heat treatment, welding, cutting, engraving, and so forth.

Cleaning system 42 generally includes operator-based equipment 46 positioned at an operator station 48, remote-based equipment 50 located in very high radiation area (VHRA) 28, and intermediate-based equipment 52 located at an intermediate area 54 just outside of VHRA 28. Operator station 48 represents an area within the nuclear reactor facility of environment 40 in which operators 56 may be located without being exposed to unacceptably high radiation levels. As defined previously, VHRA 28 represents an area within environment 40 accessible to individuals, in which radiation levels could exceed 500 rad (5 gray) in one hour at 1 meter from the source or from any surface that the radiation penetrates. Intermediate area 54 represents an area within environment 40 in which radiation levels are lower than those of VHRA 28, but may be higher than radiation levels within operator station 48.

In general, operator-based equipment 46 of cleaning system 42 includes a vehicle controller 58 in communication with a processor 60 and optionally in communication with a cleaning system monitor 62. Remote-based equipment 50 of cleaning system 42 includes a remote interface 64, a cable tensioner 66, and a cleaning vehicle 68. Intermediate-based equipment 52 includes a vessel 70 containing a cleaning medium 72 whose delivery may be controlled via a cleaning medium actuator 73 positioned at operator station 48. Intermediate-based equipment 52 further may further include an air line 74 coupled to an air source 76, which may be a “plant-provided source.” Air source 76 is further in communication with vessel 70 via a second air line 77.

Cleaning vehicle 68 exhibits a height of less than twelve inches and a width of less than twelve inches so that it may be installed through an existing twelve inch by twelve inch access panel 78 in insulation package 26. Thus, cleaning vehicle 68 is positioned on insulation floor 27 beneath reactor pressure vessel 20. Similarly, cable tensioner 66 is sized such that it may be installed through access panel 78. Remote interface 64 need not be installed through access panel 78 however. Rather, remote interface 64 may be located underneath reactor pressure vessel, just outside of insulation package 26, but still within VHRA 28. Operator-based equipment 46 enables operators 56, positioned within operator station 48, to remotely control remote-based equipment 50 in VHRA 28. In addition, operators 56 may occasionally access intermediate area 54 to manipulate intermediate-based equipment 52 without entering VHRA 28. Thus, radiation exposure to personnel is significantly reduced relative to manually cleaning penetration regions 30 of BMI nozzles 22. In addition, since cleaning vehicle 68 is installed underneath reactor pressure vessel 20 through an existing access panel 78 in insulation package 26, significant time and cost savings are realized by not having to implement modifications to insulation package 26.

Vehicle controller 58 is coupled to remote interface 64 within VHRA 28 via an interface communication cable 80. Remote interface 64 is, in turn, coupled to cleaning vehicle 68 via a vehicular communication and power cable 82. Air line 74 is coupled to remote interface 64, and a vehicular air line 84 interconnects remote interface 64 and cleaning vehicle 68. A media delivery hose 86 interconnects vessel 70 containing cleaning medium 72 with cleaning vehicle 68.

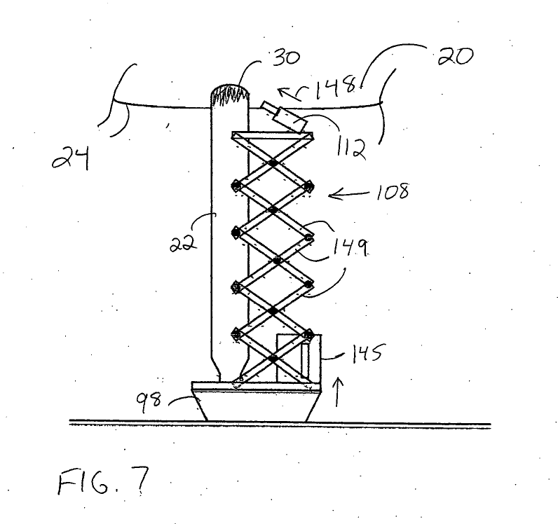

Vehicular communication cable 82, air line 84, and media delivery hose 86 are routed through cable tensioner 66. Consequently, the reference numerals representing the vehicular communication cable, i.e., reference numeral 80, the vehicular air line, i.e., reference numeral 84, and the media delivery line, i.e., reference numeral 86, remain the same on either side of cable tensioner 66. Generally, cable tensioner 66 is a cable management pulley system for keeping vehicular communication cable 82, vehicular air line 84, and media delivery hose 86 that are attached to cleaning vehicle 68 relatively taut. The structure and function of cable tensioner 66 will be described in greater detail in connection with FIG. 7.

Remote interface 64 serves as a hub, or interface, between vehicular controller 58 and cleaning vehicle 68. Remote interface 64 may serve as a control signal/video pass-through for signaling between vehicular controller 58 and cleaning vehicle 68. Power may additionally be bundled with the control signals and video in vehicular communication cable 82.

Remote interface 64 further serves as a hub, or interface, between air source 76 and cleaning vehicle 68. Although cleaning vehicle 68 is primarily electrically powered via motors, some elements are powered by fluid. That is, energy is transmitted to cleaning vehicle 68 by pressurizing and controlling a contained fluid, i.e., air, in order to operate some components of cleaning vehicle 68.

Remote interface 64 may include a manifold system (not shown) that receives air from air line 74, and distributes that air to multiple smaller tubes (not shown). These multiple smaller tubes are desirably bundled to form vehicular air line 84. Alternatively, a manifold system may be positioned on cleaning vehicle 68. As such, air is delivered to the manifold system on cleaning vehicle 68 via vehicular air line 84 where it is subsequently distributed to multiple smaller tubes (not shown) to actuate the pneumatically driven components of cleaning vehicle 68.

Robotic applications, such as cleaning vehicle 68, typically involve relatively low-speed, high precision motions. Consequently, in a preferred embodiment, electrically-driven components are utilized with cleaning vehicle 68 because of their high precision, lightweight actuators. However, it should be understood that pneumatic and/or hydraulic systems may alternatively be utilized within cleaning vehicle 68.

Vessel 70, containing cleaning medium 72, is positioned near, but outside of VHRA 28, so that cleaning medium 72 has a relatively short distance to travel through media delivery hose 86. In a preferred embodiment, cleaning system 42 utilizes a carbon dioxide cleaning methodology where cleaning medium 72 is supercritical carbon dioxide in the form of dense dry ice pellets. Thus, the cleaning medium will be referred to hereinafter as carbon dioxide pellets 72. As will be discussed in greater detail below, cleaning vehicle 68 delivers carbon dioxide pellets 72 at a high speed to circumferential surface 34 of about each penetration region 30 of BMI nozzles 22 to remove protective coating 32. Carbon dioxide pellets 72 are a preferred cleaning medium because they are a nontoxic, nonflammable material, with no ozone depleting potential. Moreover, upon impact, carbon dioxide pellets 72 sublimate to a gaseous state, leaving the surface clean, dry and undamaged, while keeping the area free from secondary waste and debris.

Although carbon dioxide pellets 72 are preferred, it should be understood that the present invention may be adapted to include another cleaning medium. If an alternative cleaning medium is employed that generates secondary waste, another vessel (not shown), interconnected with cleaning vehicle 68 via a waste vacuum hose (not shown), may be provided at intermediate area 54 for collecting the secondary waste.

Inspection system 44 is a standard mobile inspection system, also known as a camera crawler. Inspection system 44 includes an inspection controller 90 in communication with an inspection monitor 92, both of which are positioned at operator station 48. Inspection controller 90 controls movement of an inspection camera 94 via a communication link 96. Inspection camera 94 may be installed through access panel 78 in insulation package 26, and is positioned on insulation floor 27 beneath reactor pressure vessel 20.

Inspection camera 94 is highly maneuverable, and may be used to locate lanes between BMI nozzles 22 through which cleaning vehicle 68 can be directed. Thus, inspection system 44 can be used as a guide for cleaning vehicle 68. In addition, following cleaning, inspection system 44 may be utilized for the bare-metal inspections of BMI nozzles 22. Although not shown, a stationary camera may also be located underneath reactor pressure vessel 20 for providing a global view of lower head 24 of pressure reactor vessel. However, such a camera would not be used for bare-metal inspections.

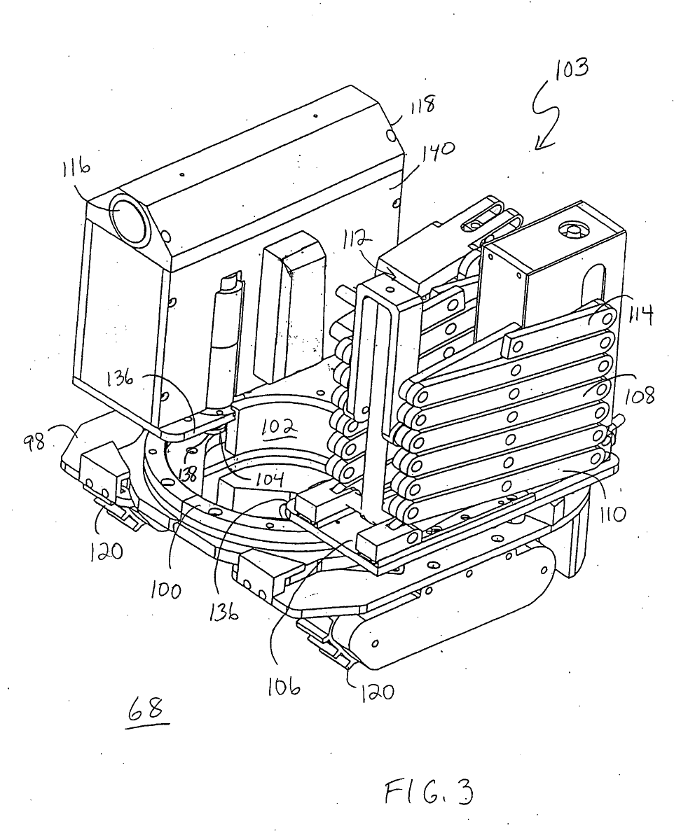

Referring to FIGS. 1 and 3, FIG. 3 shows a perspective view of cleaning vehicle 68 in accordance with a preferred embodiment of the present invention. Cleaning vehicle 68 is adapted to fit within access panel 78 to clean BMI nozzles 22 penetrating lower head 24 of pressure reactor vessel 20. Movement of cleaning vehicle 68 is directed by vehicle controller 58 (FIG. 2) positioned remotely at operator station 48 (FIG. 2).

Cleaning vehicle 68 includes a base 98 moveable along insulation floor 27 and a clamp 100 mounted on base 98. A collar element 102 is fixed to and extends from base 98. In a first turntable configuration 103, cleaning vehicle 68 includes a rotating member 104 and a platform 106 rotatably coupled to collar element 102. The descriptive term “turntable” is utilized herein to emphasize the capability of platform 106, and consequently those elements coupled to platform 106, to rotate relative to base 98. The advantages of this rotational capability will become apparent in the ensuing discussion.

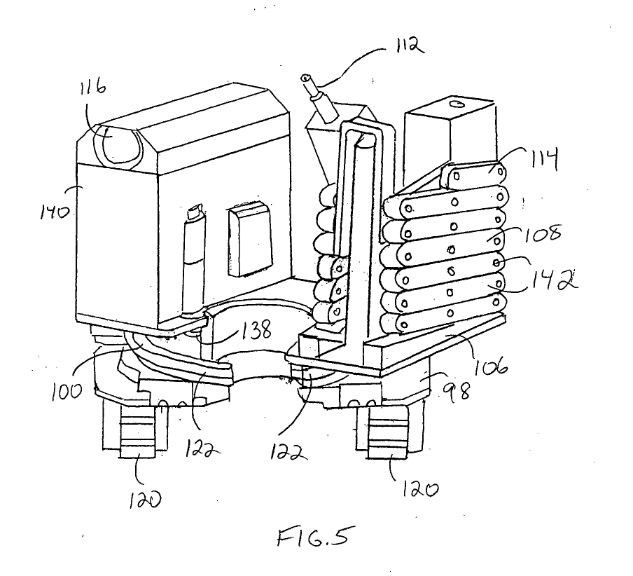

A jack 108 is positioned upon platform 106. Jack 108 has a first end 110 in communication with base 98 via platform 106. An effector, in the form of a nozzle 112 oriented at a suitable inclination, is coupled to a second end 114 of jack 108 (see also FIG. 5). Jack 108 is a conventional scissor-style jack that is extendible to lift nozzle 112 vertically above base 98. Base 98, rotating member 104, and jack 108 may be pneumatically actuated by air provided via vehicular air line 84 (FIG. 2) or may be actuated via electric motors.

Cleaning vehicle 68 may also include a camera system having a front camera 116 and a rear camera 118 (not visible) that provide front and rear views of a path of travel of cleaning vehicle 68. These front and rear views may subsequently be displayed on cleaning system monitor 62 (FIG. 2) at operator station 48 (FIG. 2).

In a preferred embodiment, cleaning vehicle 68 is a tracked vehicle. As such, base 98 includes dual motorized endless treads 120, sometimes referred to as caterpillar treads. Endless treads are typically found on tanks, bulldozers, and the like. Endless treads 120 enable cleaning vehicle 68 to distribute its weight more evenly over insulation floor 27 so as to facilitate the maneuverability of cleaning vehicle 68.

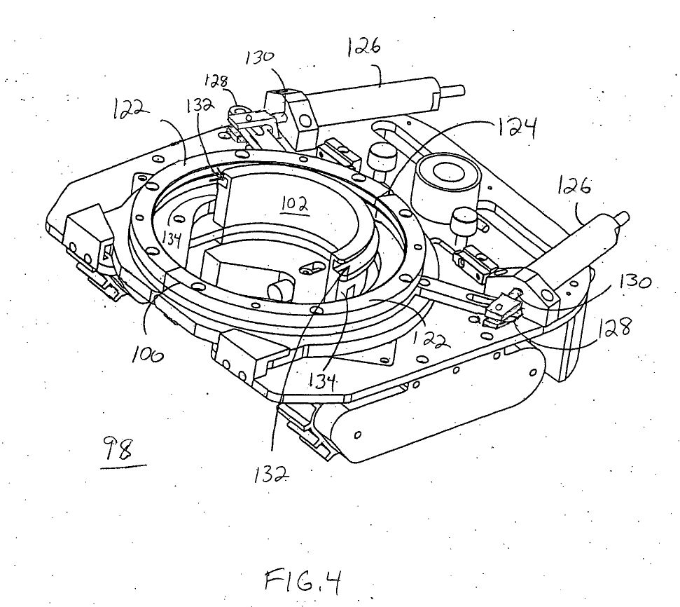

Referring to FIG. 4 in connection with FIG. 3, FIG. 4 shows a perspective view of base 98 of cleaning vehicle 68 with clamp 100 mounted thereon. Clamp 100 is configured to attach to and encircle one of BMI nozzles 22 (FIG. 1) to retain cleaning vehicle securely to columnar elements, such as, BMI nozzles 22. Clamp 100 includes jaws 122 coupled at a hinge point 124. Pneumatically-driven actuators 126 are in communication with each of jaws 122 of clamp 100 via linkage 128. In an exemplary embodiment, each of actuators 126 may include an extensible rod 130 interconnected with linkage 128. As rods 130 extend from actuators 126, the interconnected linkage 128 imparts force on jaws 122 to open clamp 100. Conversely, as rods 130 are pulled into actuators 126, the interconnected linkage 128 imparts an opposite force on jaws 122 to close clamp 100.

With continued reference to FIGS. 3-4, collar element 102 includes a groove 132 located along an outer surface 134 of collar element 102 for retaining an inner edge 136 of platform 106 of rotating member 104. Rotating member 104 further includes a gear 138 abutting outer surface 134 of collar element 122 beneath platform 106. Gear 138 is mounted on a motorized shaft extending through platform 106 and housed within a housing 140 on platform 106. When the motorized shaft is directed to rotate via vehicular controller 55, gear 138 rotates in cooperation with the motorized shaft. The engagement between gear 138 and outer surface 134 causes platform 106 to move within groove 132. Consequently, platform 106 and the attached jack 108, nozzle 112, front camera 116, and rear camera 118 rotate relative to the stationary collar element 102 of base 98.

Although an exemplary rotating member 104 is described herein, those skilled in the art will recognize that the present invention may be adapted to include alternative means for enabling rotation of platform 106 and the attached jack 108, nozzle 112, front camera 116, and rear camera 118 relative to base 98.

FIG. 5 shows a front elevation view of cleaning vehicle 68. As shown, hinged jaws 122 of clamp 100 have been actuated into an open position. In addition, platform 106 has been actuated to rotate relative to base 98. The advantages of these functions will be described below in connection with a methodology for cleaning penetration regions 30 (FIG. 1) of BMI nozzles 22 (FIG. 1).

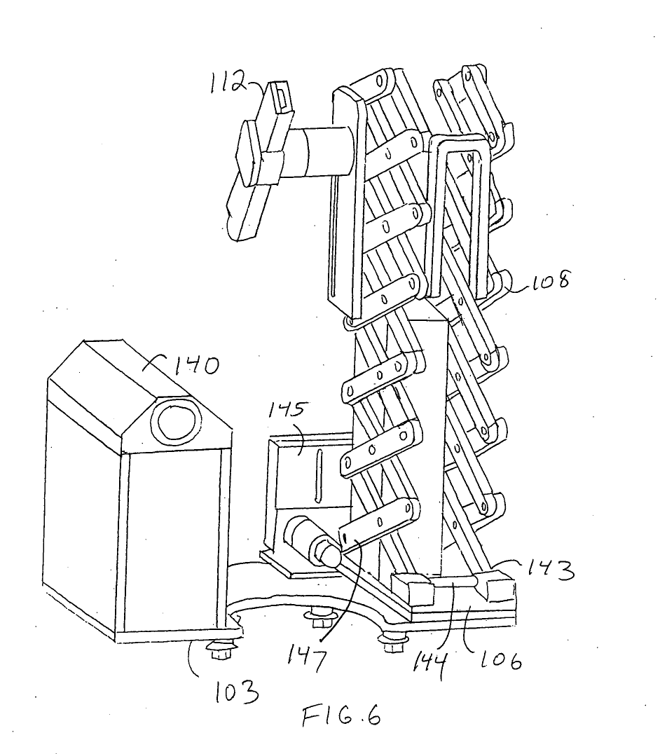

FIG. 6 shows a perspective view of turntable portion 103 with jack 108 in an extended position. As particularly shown in FIG. 6, a front, lowermost, edge 143 of jack 108 is coupled to platform 106 via a pivot hinge 144. A jack tilt mechanism 145, for example, a jack screw, is coupled to a rear edge 147 of jack 108. Jack tilt mechanism 145 provides the ability to allow jack 108 to tilt forward to bring nozzle 112 closer to penetration region 30 (FIG. 1) of one of the BMI nozzles 22 (FIG. 1). This feature is advantageously employed in areas where unevenness in insulation floor 27 results in nozzle 112 not being appropriately positioned for cleaning.

Referring to FIGS. 3 and 7, FIG. 7 shows a side elevation view of cleaning vehicle 68 extended to reach penetration region 30 of one of the BMI nozzles 22. Lower head 24 of reactor pressure vessel 20 is curved. As such, the clearance between lower head 24 and insulation floor 27 changes from the center toward the periphery. In an exemplary scenario, the clearance between lower head 24 and insulation floor 27 may range from eight inches at the center, bottom of lower head 24, to approximately forty-six inches at the periphery of lower head 24. Accordingly, penetration regions 30 of BMI nozzles 22 are at varying heights.

Jack 108 is a scissor-type jack having arms 142 for lifting nozzle 112 that when extended, form the shape of a diamond. When jack 108 is in a fully contracted position, as shown in FIG. 3, cleaning vehicle 68 is low enough so that nozzle 112 can reach penetration regions 30 in areas wherein clearance is only eleven inches. However, jack 108 is extensible up to approximately forty two inches so that nozzle 112 can reach penetration regions 30 about the periphery of lower head 24.

In addition, jack tilt mechanism 145 can be optionally actuated to lift rear edge 147 of jack 108, thus pivoting jack 108 about pivot hinge 144 (FIG. 6). Such actuation results in nozzle 112 moving forward, toward penetration region 30, as represented by an arrow 148.

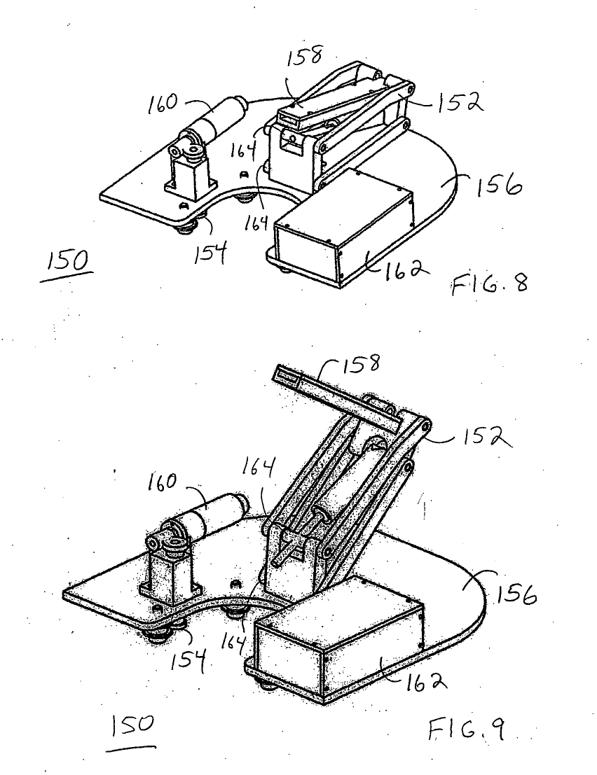

Referring to FIGS. 8-9, FIG. 8 shows a perspective view of a second turntable configuration 150 of cleaning vehicle 68 (FIG. 3) in accordance with an alternative embodiment of the present invention. FIG. 9 shows a perspective view of second turntable configuration 150 having a jack 152 in an extended position mounted thereon. Second turntable configuration 150 is interchangeable with first turntable configuration 103. As such, second turntable configuration 150 may be readily rotatably coupled with base 98 (FIG. 3).

As discussed in connection with FIG. 7, lower head 24 of reactor pressure vessel 20 is curved, and the clearance between lower head 24 and insulation floor may be as low as eight inches at the center, bottom of lower head 24. First turntable configuration 103 (FIG. 3) functions adequately for clearances of approximately eleven inches and higher. In contrast, second turntable configuration 150 has a lower profile than first turntable configuration 103, and is advantageously adapted to perform work processes in lower clearance regions, for example, the eight inch clearance at the center, bottom of lower head 24.

Second turntable configuration 150 includes a rotating member 154, in the form of a gear, and a platform 156 that rotatably engage with collar element 102 (FIG. 3) in the previously described manner. Jack 152 is positioned upon platform 156, and an effector, in the form of a nozzle 158 oriented at a suitable inclination, is coupled to jack 152. A low profile motor and housing 160 may be coupled to platform 156 for enabling movement of platform 156 relative to base 98 (FIG. 3). In addition, control circuitry, motors, connection points, and so forth may be integrated into a low profile housing 162 mounted on platform 156.

Jack 152 is coupled to platform 156 via pivot hinges 164. An actuator 166 of jack 152 is employed to extend jack 152. In particular activation of actuator 166 causes jack 152 to pivot about pivot hinges 164. This pivoting action results in the imposition of both a vertical lift and a forward tilt on nozzle 158, so as to appropriately position nozzle 158 for cleaning penetration regions 30.

For completeness of discussion, two turntable configurations are described in detail herein, i.e., first turntable configuration 103 with jack 108 and usable in high clearance regions, and second turntable configuration 150 with jack 152 and usable in low clearance regions. However, those skilled in the art will readily recognize that the concepts discussed herein may be adapted to suit a wide variety of clearance profiles.

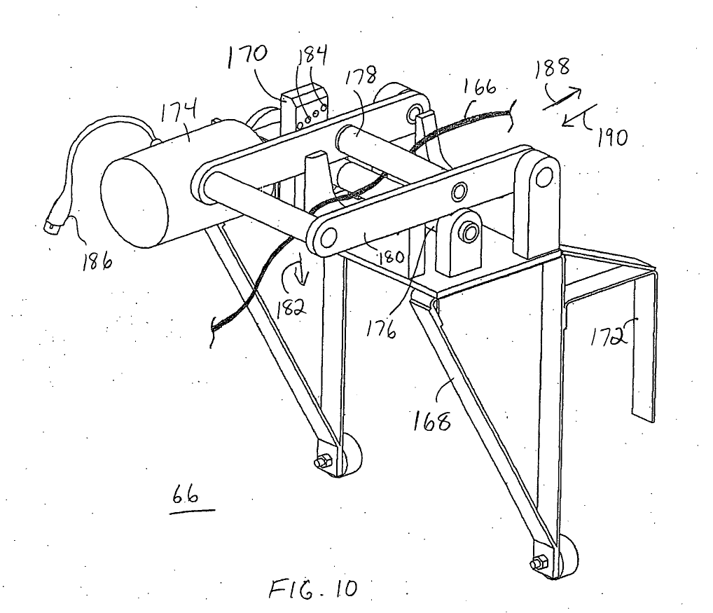

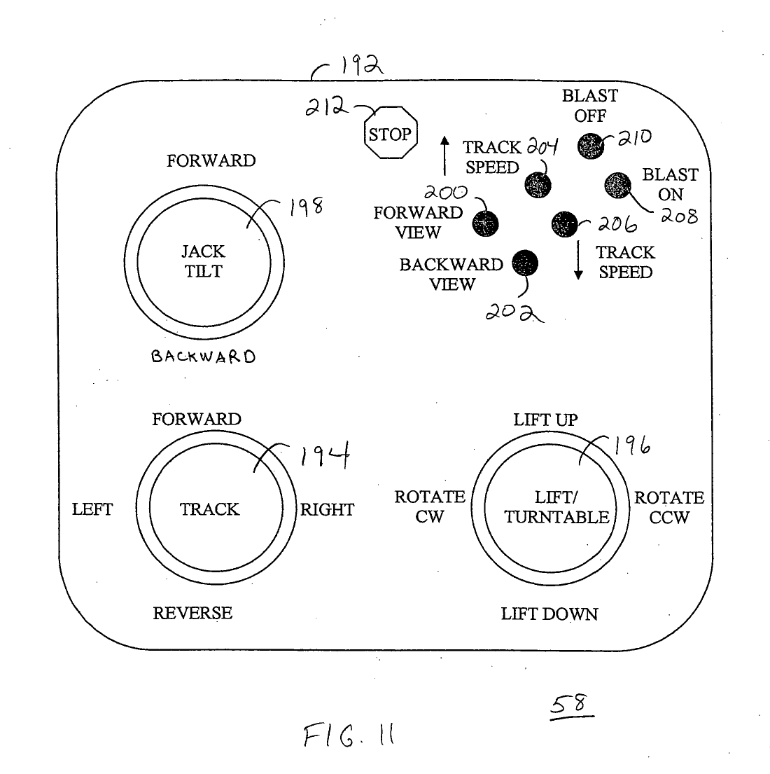

FIG. 10 shows a side view of cable tensioner 66 that may be utilized in exemplary environment 40 (FIG. 2). Referring momentarily to FIG. 1, there may be approximately sixty BMI nozzles 22 underneath reactor pressure vessel 20 in an exemplary scenario. Accordingly, cleaning vehicle 68 is compelled to travel a circuitous path when maneuvering around so many BMI nozzles 22. Moreover, cleaning vehicle 68 must travel this circuitous path with vehicular communication cable 82 (FIG. 2), vehicular air line 84 (FIG. 2), and media delivery hose 86 (FIG. 2) in tow. In such a situation, cleaning vehicle 68 can become hung up on, or otherwise entangled in vehicular communication cable 82, vehicular air line 84, and/or media delivery hose 86 as cleaning vehicle 68 moves beneath reactor pressure vessel 20. For brevity, the combination of vehicular communication cable 82, vehicular air line 84, and media delivery hose 86 will be referred to collectively as a cable system 166.

Cable tensioner 66 functions to provide an additional amount of cable system 166 as cleaning vehicle 68 moves forward (i.e., away from cable tensioner 66). In addition, cable tensioner 66 functions to remove an excess amount of cable system 166 as cleaning vehicle 68 moves backward (i.e., toward cable tensioner 66). To that end, cable tensioner 66 includes a frame structure 168 that holds a body 170 and a pair of hooks 172 (of which one is shown). Hooks 172 are utilized to attach cable tensioner 66 to insulation package 26 (FIG. 1). More specifically, hooks 172 attach to insulation package 26 by hooking onto insulation package 26 at access panel 78 (FIG. 1). This prevents cable tensioner 66 from moving when tension is placed on cable system 166, as discussed below.

Cable tensioner 66 includes a motor 174 to which a first roller 176 is coupled. A second roller 178 is coupled to a lever arm 180. As shown, cable system 166 is routed between first and second rollers 176 and 178 when lever arm 180 is lifted in an upward position. Lever arm 180 may then be moved downwardly, as indicated by an arrow 182, and pinned into place utilizing a pin (not shown) directed through one of engagement holes 184 of body 170. Consequently, second roller 178 is secured so as apply pressure on cable system 166. A drive input 186 is in communication with motor 174. Drive input 186, in the form of a cable connection, is further in communication with vehicle controller 58.

In a preferred embodiment, cable tensioner 66 is under automatic control by vehicle controller 58. That is, vehicle controller 58 directs motor 174 to drive cable system 166 in one of a first direction, represented by a first arrow 188, and a second direction, represented by a second arrow 190. Vehicle controller 58 may actuate motor 174 via-drive input 186, in response to a forward command or a backward command given to cleaning vehicle 68 (FIG. 2). In response to actuation of motor 174, first roller 176 rotates, which in turn pulls cable system 166 in either first direction 188 or second direction 190. Thus, when cable system 166 is driven in first direction 188, an additional amount of cable system 166 will be inserted underneath reactor pressure vessel 20 (FIG. 1). Similarly, when cable system 166 is driven in second direction 190, an excess amount of cable system 166 will be removed from beneath reactor pressure vessel 120.

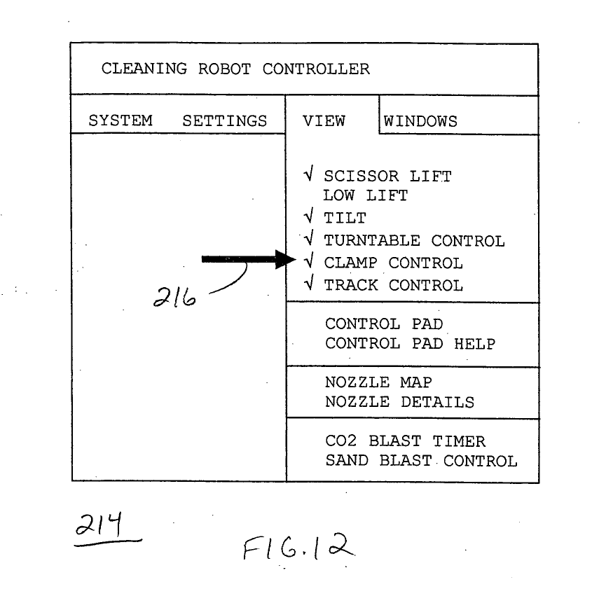

FIG. 11 shows an exemplary block diagram of a vehicle control panel 192 of vehicle controller 58 (FIG. 2) that includes a number of controls that may be operable by one of operators 56 (FIG. 2) for remote control of cleaning vehicle 68 (FIG. 3). The control of cleaning vehicle 68 may be executed utilizing an analog-based control pad having joysticks, pushbuttons, toggle elements, and so forth. As such vehicle control panel 192 represents a physically manipulated control pad.

Alternatively, the control of cleaning vehicle 68 may be executed under software control utilizing digital signaling. In such an instance, vehicle control pad 192 represents a screen image that may be displayed on a display associated with processor 60. The screen image could be a conventional graphical user interface using pull-down menus and/or direct manipulation of graphical images. Alternatively, the screen image could be displayed on a touch screen input device. Those skilled in the art will recognize that a great variety of control mechanisms, and/or a combination of analog- and processor-based control mechanisms may be employed so that operators 56 may readily control cleaning vehicle 68 positioned in a remote location. Control elements discussed in connection with vehicle control panel 192 will be described herein in terminology typically associated with an analog-based control pad. However, it should be understood that these control elements may be metaphorically represented in a screen image.

Vehicle control panel 192 includes a track control joystick element 194. Track control joystick element 194 is manipulated to direct movement of cleaning vehicle 68 in a forward, and backward direction. Element 194 is further manipulated for directing a rightward or leftward turning motion of cleaning vehicle 68.

Vehicle control panel 192 further includes a lift/turntable control joystick element 196. Lift/turntable control joystick element 196 is manipulated to extend (LIFT UP) either jack 108 (FIG. 3) or jack 152 (FIG. 8) and to lower (LIFT DOWN) jack 108 or jack 152. In addition, lift/turntable control joystick element 196 is manipulated to cause platform 106 (FIG. 3) and the attached jack 108, nozzle 112, front camera 116, and rear camera 118 (or alternatively, platform 156 (FIG. 8) and its attached components) to rotate relative to the stationary base 98 (FIG. 3). Accordingly, the rotating elements of first and second turntable configurations 103 (FIG. 3) and 150 (FIG. 8) can be directed to rotate in a clockwise direction (ROTATE CW) or in a counterclockwise direction (ROTATE CCW).

Jack 108 (FIG. 3) is tilted forward or backward by actuating jack tilt mechanism 145 (FIG. 6) via a jack tilt toggle element 198 of vehicle control panel 192. Vehicle control panel 192 may further include pushbuttons for selecting a video image for viewing on cleaning system monitor 62 (FIG. 2). For example, panel 192 includes a forward view pushbutton 200 and a backward view pushbutton 202. In addition, exemplary vehicle control panel 192 includes an increase track speed pushbutton 204 and a decrease track speed pushbutton 206 for manipulating the speed of cleaning vehicle 68.

Vehicle control panel 192 is further shown having pushbuttons for controlling the delivery of carbon dioxide pellets 72 (FIG. 2). By way of example, a BLAST ON pushbutton 208 starts delivery of carbon dioxide pellets 72, and a BLAST OFF pushbutton 210 stops the delivery of carbon dioxide pellets 72. BLAST ON and BLAST OFF pushbuttons 208 and 210, respectively, may be utilized in place of or as an adjunct to cleaning medium actuator 73 (FIG. 2) by one of operators 56 at operator station 48. A STOP pushbutton 212 may also be provided for immediately discontinuing the activities of cleaning vehicle 68, and placing cleaning vehicle 68 in a safe mode. Of course, other controls than that which are shown may be provided on vehicle control panel 192 for the further manipulation and control of cleaning vehicle 68.

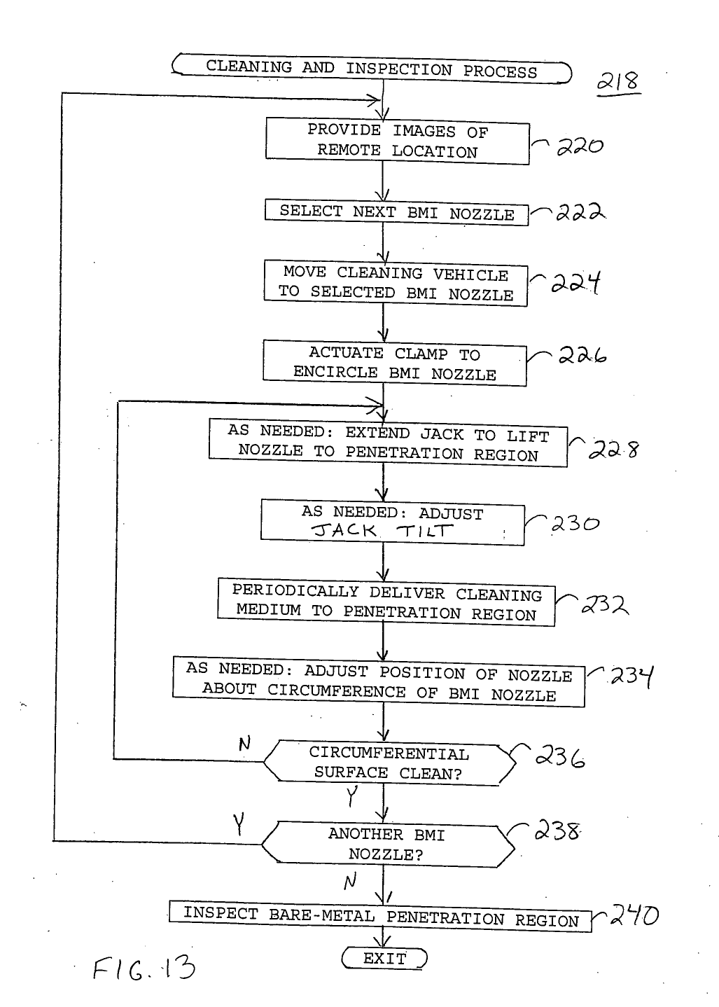

FIG. 12 shows a diagram of an exemplary drop-down menu 214 of a cleaning robot controller program. As discussed in connection with FIG. 11, cleaning vehicle 56 (FIG. 2) may be remotely manipulated utilizing an analog-based physical control pad, under software control, and or by a combination of physical controls and software control.

In this exemplary embodiment, clamp 100 (FIG. 3) is actuated via software control by selecting a clamp control viewing window 216 and following control directions (not shown) provided therein. The control directions might include clamp open and clamp close radio buttons and their associated captions, an image of clamp 100 in an open position or a closed position, and so forth.

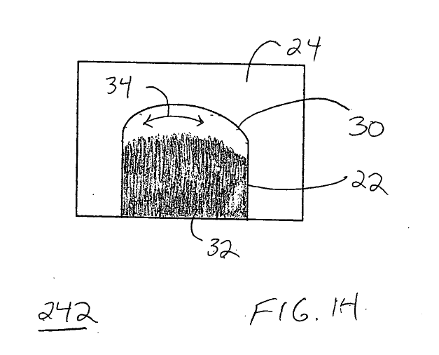

FIG. 13 shows a flowchart of a cleaning and inspection process 218 that may be performed within exemplary environment 40 (FIG. 2). Process 218 is performed to remove protective coating 32 (FIG. 1), rust, oil staining, tape, and any other potentially masking components from penetration regions 30 at each of BMI nozzles 22 utilizing cleaning system 42 (FIG. 2). A bare-metal visual inspection can subsequently be performed utilizing inspection system 44 (FIG. 2) to look for leakage at penetration regions 30. Through the utilization of cleaning system 42 and inspection system 44, radiation exposure to personnel is effectively limited. In addition, cleaning and inspecting is performed in a time and cost effective manner.

Cleaning and inspection process 218 begins with a task 220. At task 220, inspection camera 94 (FIG. 2) is deployed underneath reactor pressure vessel 20 (FIG. 1) through access panel 78 (FIG. 1). Inspection camera 94, remotely controlled at operator station 48 (FIG. 2), is manipulated to provide images of BMI nozzles 22 (FIG. 1). It is highly desirable to first provide images of BMI nozzles 22 in an “as found” state with protective coating 32 (FIG. 1) intact to first observe for identifying traces of leakage around penetration regions 30 (FIG. 1), and to ascertain the amount of protective coating 32 currently covering penetration regions 30.

A task 222 is performed in response to task 220. At task 222, one of BMI nozzles 22 is selected for cleaning. The one of BMI nozzles 22 may be selected upon the discretion of operators 56 in response to its location, amount of masking protective coating 32, and so forth.

Following the selection of one of BMI nozzles 22 at task 222, a task 224 is performed to move cleaning vehicle 68 (FIG. 2) across insulation floor 27 (FIG. 1) to the selected one of BMI nozzles 22. Cleaning vehicle 68 is remotely controlled by one of operators 56 positioned at operator station 48 using vehicle controller 58 (FIG. 2). Images provided by inspection camera 94 on inspection monitor 92 (FIG. 2) may provide guidance for the manipulation of cleaning vehicle 68 about BMI nozzles 22. In addition, images may be provided from front and rear cameras 116 and 118, respectively, (FIG. 3) for display on cleaning system monitor 62 to facilitate the manipulation of cleaning vehicle 68. As cleaning vehicle arrives at the selected one of BMI nozzles 22, clamp 100 (FIG. 3) is actuated by operator 56 to an “open” position. In such a manner, cleaning vehicle 68 can be directed so that the selected BMI nozzle 22 is positioned within a central region of cleaning vehicle 68, defined by jaws 122 (FIG. 4) of clamp 100.

Following placement of cleaning vehicle 68, a task 226 is performed to actuate clamp 100 to a “closed” position, as shown in FIG. 3. Thus, clamp 100 encircles BMI nozzle 22.

Next, a task 228 is performed as needed. At task 228, jack 108 (FIG. 3) or jack 152 (FIG. 8) is extended to lift nozzle 112 (FIG. 5) toward penetration region 30 (FIG. 1) of the selected BMI nozzle 22. It should be recalled that the height of BMI nozzles 22 from insulation floor 27 (FIG. 1) to penetration region 30 may range from approximately eight inches to forty-six inches. Accordingly, jack 108 or jack 152 is extended utilizing lift/turntable control joystick element 196 (FIG. 11) as needed to reach penetration region 30 of the selected BMI nozzle 22.

Following task 228, a task 230 may be performed as needed. At task 230, jack tilt mechanism 145 (FIG. 6) is manipulated utilizing jack tilt toggle element 198 (FIG. 11) to adjust the tilt of jack 108 (FIG. 3) so as to move nozzle 112 (FIG. 3) forward. This activity is performed so that nozzle 112 most directly points toward the region to be cleaned.

Following the execution of tasks 224, 226, 228, and 230, cleaning vehicle 68 is appropriately positioned to begin cleaning BMI nozzle 22. Accordingly, a task 232 is performed to periodically deliver carbon dioxide pellets 72 (FIG. 2) to penetration region 30. Task 200 is performed by actuation of cleaning medium actuator 73 (FIG. 2) by one of operators 56 at operator station 48. Alternatively, task 200 is performed by actuation of BLAST ON and BLAST OFF pushbuttons 208 and 210, respectively, of vehicle control panel 192 (FIG. 11).

Carbon dioxide pellets 72 are in the form of dense dry ice pellets. It has been discovered that media delivery hose 86 can stiffen and freeze due to the presence of carbon dioxide pellets 72 in it during medium delivery task 200. This situation can hinder the performance of the system and/or damage the system. In addition, damaging static potential can build up when carbon dioxide pellets 72 are delivered for a long interval. Accordingly, in a preferred embodiment, carbon dioxide pellets 72 are delivered for approximately fifteen seconds, followed by a short interval of non-delivery of pellets 72. Such a technique enables media delivery hose 86 to thaw and become more flexible.

A task 234 is performed in connection with task 232. At task 234, the position of nozzle 112 (FIG. 5), or alternatively, nozzle 158 (FIG. 8) is adjusted as needed about the circumference of BMI nozzle 22. Desirably, the nozzle position is adjusted as carbon dioxide pellets 72 exit the nozzle and begin cleaning. Nozzle 112, or nozzle 158, is adjusted about the circumference by remote control utilizing lift/turntable control joystick element 196 (FIG. 11). In addition, the extension of jack 108 (FIG. 3), or jack 152 (FIG. 8) may be optionally adjusted to accommodate any change in the curvature of lower head 24 (FIG. 1) of reactor pressure vessel 20 (FIG. 1) which results in a different height needed. In such a manner, nozzle 112, or nozzle 158, can be manipulated remotely to reach the entirety of circumferential surface 34 (FIG. 1) of BMI nozzle 22 at penetration region 30 (FIG. 1).

Nozzles 112 and 158 deliver carbon dioxide pellets 72 in a high pressure spray that effectively cleans a localized area of approximately one half inch down BMI nozzle 22 and approximately one half inch radially along lower head 24 of reactor pressure vessel 20 at penetration region 30.

Process 218 continues with a query task 236. At query task 236, operators 56 determine whether circumferential surface 34 is clean. By viewing images provided by, for example, inspection camera 94 (FIG. 2), operators 56 can determine whether a bare-metal surface has been achieved at penetration region 30. When determination is made that circumferential surface 34 is not yet clean, process control loops back to task 228 to continue making adjustments to the position of cleaning vehicle 68, and to continue periodic delivery of carbon dioxide pellets 72. However, when determination is made that circumferential surface 34 is clean, process control continues with a query task 238.

At query task 238, a determination is made as to whether another of BMI nozzles 22 (FIG. 1) is to be cleaned. When there is another BMI nozzle 22 to be cleaned, process control loops back to task 220, and the cleaning methodology of process 218 is repeated for another of BMI nozzles 22. When there are no further BMI nozzles 22 to be cleaned at query task 238, a task 240 is performed. The aforementioned tasks result in a comprehensive cleaning of all BMI nozzles 22 in need of removal of protective coating 32, as well as other obscuring contaminants. Thus, procession to task 240 indicates that BMI nozzles 22 are now clean and a bare-metal visual inspection of penetration regions 30 (FIG. 1) can commence.

At task 240, penetration regions 30 are inspected for integrity. Inspection task 240 may be performed utilizing images provided to operator station 48 via inspection camera 94. Inspection camera 94 is desirably equipped with a 300× zoom system (25× optical, 12× digital) for clearly visualizing penetration region 30.

Task 240 is illustrated as immediately following the cleaning methodology described above for simplicity of illustration. However, it should be understood that a bare-metal visual inspection of penetration regions 30 immediately following the cleaning process may not reveal any leakage residue because the leakage residue is likely to have been removed during the cleaning process. However, the immediate execution of task 240 following cleaning may be performed to obtain a baseline inspection of the structural integrity of each of BMI nozzles 22. Such an inspection may reveal cracks, metal degradation, and such that could indicate a potential leak path between lower head 24 (FIG. 1) and BMI nozzles 22 at penetration regions 30 (FIG. 1). This baseline inspection can be compared with inspections performed during subsequent refueling outages to determine any changes to the baseline status of penetration regions 30. Following task 240, cleaning and inspection process 218 exits.

FIG. 14 shows an exemplary illustration 242 of penetration region 30 of one of the BMI nozzles 22 following cleaning. Exemplary illustration 242 reveals that circumferential surface 34 at penetration region 30 of BMI nozzle 22 is now bare-metal, although protective coating 32 remains on BMI nozzle 22 outside the area of interest. This bare-metal surface enables operators 56 at operator station 48 to readily inspect penetration region 30 without excessive radiation exposure.

In summary, the present invention teaches of a system and a method for circumferential work processes and delivery of a medium. In particular, the present invention teaches of a cleaning system that includes a cleaning vehicle that is maneuverable beneath the lower head of a reactor pressure vessel, and is controlled remotely by an operator utilizing a vehicle controller. The cleaning vehicle, under the remote control of an operator, is utilized to clean a circumferential surface about a penetration region between bottom mounted instrumentation (BMI) nozzles and the lower head of a reactor pressure vessel. Once the circumferential surface is cleaned a remotely operated inspection system is utilized to inspect the penetration region for radioactive residue leakage, equipment faults, and so forth. The ability to remotely clean the penetration regions limits personnel radiation exposure to the hazardous radiation levels present in a very high radiation area of a reactor pressure vessel. In addition, the compact size and maneuverability of the cleaning vehicle enables its use underneath the reactor pressure vessel without removing the insulation package around the reactor pressure vessel. Consequently, significant savings in terms of labor costs, time, and reactor core alteration delays are realized.

Although the preferred embodiments of the invention have been illustrated and described in detail, it will be readily apparent to those skilled in the art that various modifications may be made therein without departing from the spirit of the invention or from the scope of the appended claims. For example, the robotic system may be adapted to perform other work processes on columnar elements including, but not limited to, heat treatment, welding, cutting, engraving, and so forth.

What is claimed is:

1. A system for treating a columnar element at a remote location comprising:
a vehicle moveable along a floor of said remote location;
an effector mounted on said vehicle; and
a controller positioned remote from said vehicle, said controller being in communication with said vehicle for directing movement of said vehicle to said columnar element and for enabling said effector to act upon a circumferential surface of said columnar element.

2. A system as claimed in claim 1 wherein said vehicle further includes a clamp for clamping attachment to said columnar element.

3. A system as claimed in claim 2 wherein said vehicle further includes an actuator in communication with said clamp, said clamp includes hinged jaws, and said actuator actuates said hinged jaws to encircle said columnar element in response to direction from said controller.

4. A system as claimed in claim 1 wherein said vehicle further includes:
a base moveable along said floor; and
a jack having a first end in communication with said base and having a second end, said effector being coupled to said second end, and said jack being extendible to lift said effector above said base.

5. A system as claimed in claim 4 further comprising:
a pivot hinge coupling a front edge of said first end of said jack to said base; and
means, interposed between said jack and said base, for pivoting said jack about said pivot hinge to tilt said jack in a forward direction.

6. A system as claimed in claim 1 wherein said vehicle further includes:
a base moveable along said floor; and
a rotating member coupled between said base and said nozzle, said rotating member being configured to rotate relative to said base to enable said effector to act upon said circumferential surface of said columnar element.

7. A system as claimed in claim 1 wherein said vehicle is a tracked vehicle having endless tracks.

8. A system as claimed in claim 1 wherein said effector is a nozzle for delivering a medium to said circumferential surface of said columnar element.

9. A system as claimed in claim 8 wherein said columnar element is bottom mounted instrumentation (BMI) that penetrates a reactor pressure vessel of a nuclear reactor at a penetration region, and said nozzle is configured to deliver said medium to said penetration region of said BMI to clean said penetration region prior to a visual examination.

10. A system as claimed in claim 8 wherein said medium is a carbon dioxide cleaning medium.

11. A system as claimed in claim 8 further comprising:
a vessel positioned remote from said vehicle and containing said medium; and
a hose coupled between each of said vessel and said nozzle for delivering said medium from said vessel to said nozzle.

12. A system as claimed in claim 1 wherein said controller is configured for manipulation by an operator, and said system further comprises a camera mounted on said vehicle for providing images of said remote location to said operator.

13. A system as claimed in claim 1 further comprising:
a control cable coupled between said vehicle and said controller; and
a cable tensioner interfaced with said control cable, said cable tensioner functioning to remove an excess amount of said control cable from said remote location and to insert an additional amount of said control cable to said remote location as said vehicle moves about said remote location.

14. A system as claimed in claim 13 wherein said cable tensioner comprises:
a motor for driving said control cable in either of a first direction and a second direction; and
a drive input in communication with said motor and said controller, said controller directing said motor to drive said control cable in one of said first direction and said second direction in response to said movement of said vehicle.

15. A method for cleaning bottom mounted instrumentation (BMI) at a penetration region of a reactor pressure vessel, said method comprising:
remotely directing a vehicle to said BMI; and
remotely enabling delivery of a frozen carbon dioxide medium from a nozzle of said vehicle to said penetration region.

16. A method as claimed in claim 15 further comprising positioning said vehicle in clamping engagement with said BMI prior to delivery of said frozen carbon dioxide medium.

17. A method as claimed in claim 15 wherein said penetration region is positioned at a distance above a floor underneath said pressure reactor vessel, said vehicle is moveable along said floor, and said method further comprises adjusting a height of said nozzle to reach said penetration region.

18. A method as claimed in claim 15 further comprising rotating said nozzle about said BMI to clean a circumferential surface of said BMI at said penetration region.

19. A method as claimed in claim 15 further comprising periodically repeating said enabling operation separated by intervals of non-delivery of said frozen carbon dioxide medium.

20. A method for treating a columnar element at a remote location using a remote controlled vehicle, said vehicle including a moveable base, a clamp mounted on said base, a jack in communication with said base, and an effector coupled to an end of said jack, said method comprising:
directing movement of said vehicle to said columnar element;
actuating hinged jaws of said clamp to encircle said columnar element;
extending said jack to lift said effector above said base; and
enabling said effector to act upon a surface of said columnar element.

21. A method as claimed in claim 20 wherein said vehicle includes a rotating member coupled to said base and configured to rotate relative to said base, said effector being coupled to said rotating member, and said method further comprises adjusting a position of said effector via said rotating member to enable said effector to act upon a circumference of said columnar element.

22. A method as claimed in claim 20 wherein said vehicle includes a camera, and said method further comprises providing images of said surface via said camera following said delivering operation.

23. A system for cleaning a columnar element at a remote location comprising:
a vehicle including:
a base moveable along a floor of said remote location;
a clamp mounted on said base for clamping attachment to said columnar element;
a rotating member coupled between said base and configured to rotate relative to said base about said columnar element; and
an effector in communication with said rotating member so that rotation of said rotating member causes rotation of said effector; and
a controller positioned remote from said vehicle, said controller being in communication with said vehicle for directing movement of said effector to said columnar element and for enabling said effector to deliver a cleaning medium to a circumferential surface of said columnar element.

24. A system as claimed in claim 23 wherein said vehicle further includes a jack having a first end in communication with said base and having a second end, said effector being coupled to said second end, and said jack being extendible to lift said effector above said base.

25. A system as claimed in claim 24 wherein said vehicle further includes:
a pivot hinge coupling a front edge of said first end of said jack to said base; and
means, interposed between said jack and said base for pivoting said jack about said pivot hinge to tilt said jack in a forward direction.

26. A system for remote cleaning of a penetration region of bottom mounted instrumentation (BMI) that penetrates a reactor pressure vessel of a nuclear reactor comprising:
a vehicle including:
a base moveable along a floor of said remote location;
a rotating member coupled to said base;
a jack having a first end in communication with said rotating member and having a second end; and
a nozzle coupled to said second end of said jack, said jack being extendible to lift said nozzle above said base and said rotating member being configured to rotate relative to said base about said BMI to enable said nozzle to deliver said cleaning medium about a circumference of said penetration region; and
a controller positioned remote from said vehicle, said controller being in communication with said vehicle for directing movement of said nozzle to said penetration region and for enabling said nozzle to deliver said cleaning medium to said circumference of said penetration region.
